(19) United States
(12) Patent Application Publication
(10) Pub. No.: US 2012/0018590 A1
(43) Pub. Date: Jan. 26, 2012

(54) Bernoulli Micro Plane

(76) Inventors: Michael Sivan, Shatin-Fotan (HK); Nicolas Paquet, Brussels (BE)

(21) Appl. No.: 12/839,423

(22) Filed: Jul. 20, 2010

(51) Int. Cl. B64C 3/32

(52) U.S. Cl. 244/45 R

(57) ABSTRACT

A low cost method for motorized small indoor toy airplanes that significantly boosts the lifting forces resulting from Bernoulli Principle, and as such providing for a significantly reduced flying speed of that airplane, improved flight control, smaller turning radius and ability to fly in a much smaller room.

### FIELD OF THE INVENTION

Indoors flying motorized toy airplanes.

### BACKGROUND OF THE INVENTION

Current small indoor flying toy airplanes are limited to a minimal size, minimal speed of flight and minimal radius of turn. This is due to constraints of weight and basic aerodynamics. As such it is difficult to remote control them, and they require larger rooms to make turns or ‘8’ shaped flight pattern (the favorite remote control pattern). This excludes a high percentage of users whose homes are not large enough, and excludes younger users and other users who have difficulty to reach high level of proficiency in remote control handling.

To enable easier remote control, more stability and more flight agility so that a larger number of users can benefit of playing with indoor airplanes, there is a need to improve the toy airplanes so that they can fly much slower, and can turn at much smaller angles.

This invention provides for a method to overcome, at virtually no increase of cost, the basic aerodynamics restrictions allowing smaller-sized airplanes to fly at significantly lower speeds and to turn at smaller radii. This invention opens a major new window of opportunities for toy airplanes.

### SUMMARY OF THE PRESENT INVENTION

The minimal flight speed of state-of-the-art toy planes is determined by the wing load. Wing load is the overall weight of the airplane (including motors, batteries, electronics, etc.) divided by the wings surface area. To slow down the flight—either the weight must be reduced, and/or the wings must be enlarged. There is a limit to the ability to reduce the weight, and increasing the wings—limits the overall maneuverability within a confined room. These 2 factors limit the ability to reduce flight speed.

This invention provides a method for achieving a significantly lower flight speed for the same given wing area and weight.

To achieve this:

The biplane's parts (body, wings, tail, motor, battery, electronics, etc.) are positioned in such way that the Center of Gravity ('CG') will be just under the upper wing 3. The motor with its propeller 1 are positioned exactly in the CG as shown, and not on top or bottom of the CG. Consequently, acceleration in the speed of the motor will not create a torque on the airplane to pull down or up its nose.

The motor and its propeller are tilted upwards at an angle 4. This provides for an upwards vertical component of the rotating propeller force FPU. This is the first contribution of this invention as it reduces the weight that the wings themselves need to carry to mg−FPU where mg is the weight of the airplane. In other words, the effective weight on the wings is reduced significantly.

Second and most significant contribution to the overall lift results from the positioning of the propeller relative to both wings:

Lower Wing—It is positioned above the lower wing. Not in front or behind the lower wing. This structure causes a very strong flow of air 5 on the upper side of the lower wing, while not pushing at all any air on the lower side of the lower wing. This maximizes the difference in speed of the air flow between the upper side 5 and the air flow of the lower side of the lower wing 6, which consequently maximizing the lift force FBU on the lower wing resulting from BE. This is different than state-of-the-art airplanes which mostly rely on asymmetry of the wing profiles to create a longer path for the air flow on the upper side of a wing so as to create a faster flow and lower air pressure on the top side of the wing (BE) to create an uplift force (FIG. 2).

Upper Wing—the propeller pushes the air equally on both sides of the top wing, thus no BE force is created on the upper wing.

The upper wing 3 is also tilted upwards. This provides for an additional upwards vertical component FWU resulting from the wind coming from the front while moving.

A stabilizing tail 7 is provided as well.

### BRIEF DESCRIPTION OF THE DRAWINGS

FIG. 1—Cross section of the biplane in the invention

FIG. 2—Cross section of typical state-of-the-art airplane

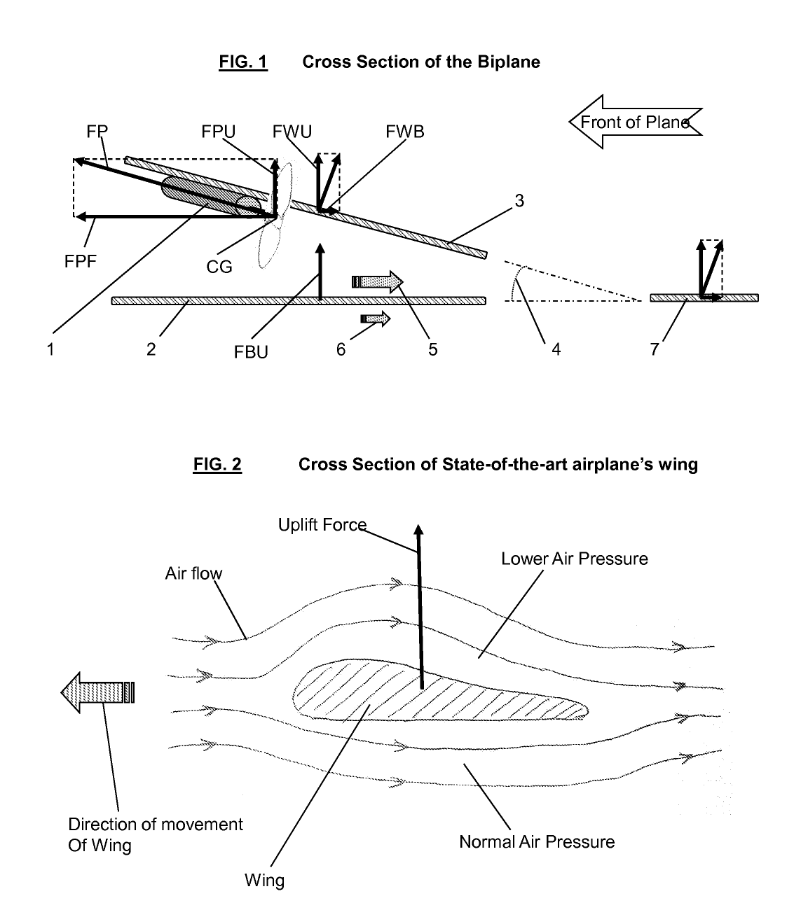

1. Motorized toy biplane in which the driving propeller is located on the middle (about) of the lower-side of the top wing in such a way that the airflow created by the propeller is almost entirely on the upper side of the lower wing and not on the lower side of the lower wing. At same time the propeller is located in the middle (about) of an opening in the upper wing, which provides for almost equal airflow created by the propeller on the upper side and lower side of the upper wing.

2. Motorized toy biplane as provided in claim 1 in which the upper wing is slightly tilted upwards to create an additional lift.
